(19) United States
(12) Patent Application Publication
(10) Pub. No.: US 2004/0113975 A1
(43) Pub. Date: Jun. 17, 2004

(54) Color printing with reduced hue shift

(75) Inventors: Michael A. Brookmire, Washougal, WA (US); Richard M. Vogel, Pittsford, NY (US); Chris Abbe, Webster, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/420,103

(22) Filed: Apr. 18, 2003

Related U.S. Application Data
(60) Provisional application No. 60/433,391, filed on Dec. 13, 2002.

(51) Int. Cl. B41J 2/145; B41J 2/15

(52) U.S. Cl. 347/40

(57) ABSTRACT

A direct marking, bidirectional, swathing printer eliminates hue shift between forward and reverse directions swath of the printhead by including at least two sets of printheads, with each set including a printhead for each of the set of colors deposited by the printhead. The color order of the different printheads of each set are different between the two sets, and preferably in reverse order, so that as the printheads move in both the forward and reverse directions alternating rows of dots are formed in reverse color order, so that hue shift due to the order in which colors are deposited occurs on a dot to dot basis, rather than on a swath to swath basis.

### BACKGROUND

This application is based on a Provisional Patent Application No. 60/433,391, filed Dec. 13, 2002.

The present invention relates to color printing, and is particularly applicable to printing with a reciprocating or swathing type ink jet printhead.

Swathing type ink jet printers have printheads that move across a print medium, depositing drops of ink onto the print medium as the printhead traverses the print medium. A color printer capable of printing in multiple colors has a predetermined set of ink colors that the printer deposits on the print medium in different quantities at different locations to obtain the desired finished color on the print medium. Typically, a full color ink jet printer uses a set of 4, 6, or 8 colors. For example, a four color printer typically uses yellow, magenta, cyan, and black to create the full range of printed colors. Some printers add to those four colors light magenta, light cyan, light yellow, and/or a different shade of black. In an alternative, some printers use red, green and blue as the components of the finished colors. Although the following discussion will focus on implementations with a four color supply (yellow, cyan, magenta, black), after reading the following description those skilled in the art will recognize that the principles described are applicable to other color configurations.

A high speed printer deposits all of the colors in a single pass of the printhead over the print medium. Such single pass printing provides maximum printing speed, and accurate mixing of the ink colors. A single pass, unidirectional printer has a printhead that deposits ink drops as the printhead moves in one direction across the print medium to print a swath of the image. The printer then returns the printhead to its starting position at one side of the print medium, and advances the print medium approximately the width of the printed image swath. In a unidirectional printer, the printhead ejects ink drops only as it moves in one direction across the print medium, and does not eject ink drops as it returns to its point of origin.

For higher print speeds, a printer is operated in a bidirectional mode. A high speed, single pass, bidirectional printer has a printhead that deposits ink drops as the printhead moves in both directions across the print medium. Such bidirectional printing eliminates time lost moving the printhead back to a starting position at one side of the print medium. In bidirectional printing, the printhead moves in a forward printhead travel direction across the print medium, depositing ink drops as it travels to print a first swath of the image. The media is then advanced in a media travel direction that is transverse to the printhead travel direction, and the printhead moves in the opposite (reverse) printhead travel direction, depositing ink drops as the printhead traverses the print medium to print a second, adjacent swath of the image.

In many printers, the color shades resulting from the combinations of the deposited ink colors (color hue) varies slightly between the image swaths printed when the printhead is traveling in the forward travel direction as compared with the image swath deposited when the printhead is traveling in the reverse travel direction.

### SUMMARY

A printer has a printhead travel direction and a transverse direction that is substantially perpendicular to the printhead travel direction. The printer includes a plurality of first printheads, each of which is for ejecting a different color of a set of colors, and a plurality of second printheads, each of which is for ejecting one of the colors of the set of colors. The first printheads are arranged in a first color order in the printhead travel direction, and the second printheads are arranged in a second color order in the printhead travel direction. The second color order is different from the first color order. In a particular implementation, the second color order is opposite the first color order. The first printheads are offset from the second printheads in the transverse direction.

A method of printing an image on a print medium includes moving a set of printheads in a forward printhead travel direction across the print medium. As the set of printheads moves in the forward printhead travel direction, the printheads deposit a first set of ink drops of a specified set of colors on a set of first points on the print medium. The printheads deposit the ink drops on the first points in a first color order. The printheads also deposit a second set of ink drops of the specified set of colors on a set of second points on the print medium. The printheads deposit the ink drops on the second points in a second color order, which is different from the first color order. The second points on the print medium are offset from the first points in a direction other than the printhead travel direction. In a further aspect, the method includes moving the print medium in a media travel direction that is substantially perpendicular to the printhead travel direction, and moving the set of printheads in a reverse printhead travel direction. As the set of printheads moves in the reverse printhead travel direction, the printheads deposit a third set of ink drops of the specified set of color on a set of third points on the print medium. The printheads deposit the ink drops on the third points in the first color order. The printheads further deposit a fourth set of ink drops of the specified set of colors on a set of fourth points on a print medium. The printheads deposit the ink drops on the fourth points in the second color order. The fourth points are offset from the third points in a direction other than the printhead travel direction.

### DRAWINGS

FIG. 1 is a stylistic perspective view of printheads arranged in accordance with an aspect of the present invention.

FIG. 2 is a top view of the stylistic representation of the printheads of FIG. 1.

FIG. 3 is a stylistic view of the nozzle plate side of the printheads of FIG. 2.

FIG. 4 is an enlarged view of a portion of the nozzle plate side of the printheads of FIG. 3.

FIG. 5 is a stylistic representation of a series of dots formed on a print medium in accordance with an aspect of the present invention.

FIG. 6 is a perspective view of a printer incorporating the printhead of FIGS. 1 and 2. FIG. 7 is a stylistic top view of an alternative arrangement of printheads of an alternate implementation.

FIG. 8 is a stylistic top view of a set of printheads of the prior art.

FIG. 9 is a stylistic representation of sets of ink drops deposited by the printhead of FIG. 8.

### DETAILED DESCRIPTION

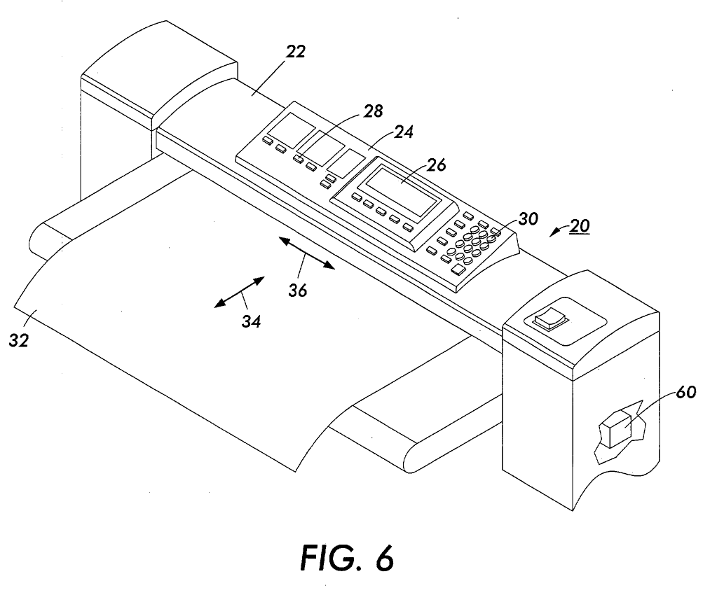

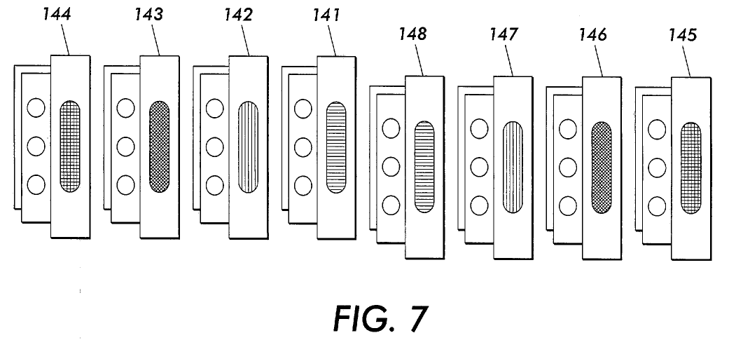

FIG. 6 shows a generalized ink jet printer 20. The particular printer illustrated in FIG. 6 is a wide format printer suitable for printing on print media 32 greater than about 36 inches in width. Those skilled in the art will recognize that the principles described herein are also applicable to others sizes of printers, including both wide format and standard office format printers. The principles described here are applicable to different types of ink jet or direct marking printing technologies, such as thermal ink jet or piezo-electric ink jet.

The printer includes a housing 22, and a user interface 24. The user interface includes a graphical display 26 and switches or buttons 28, 30 and other elements for interaction between the printer and the user. A media transport mechanism, such as powered rollers (not shown), moves the print medium 32 in a media travel direction 34. Those skilled in the art are familiar with such media transport mechanisms.

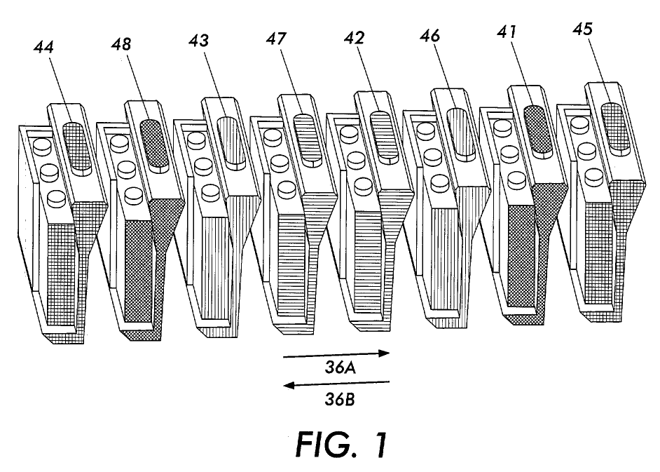

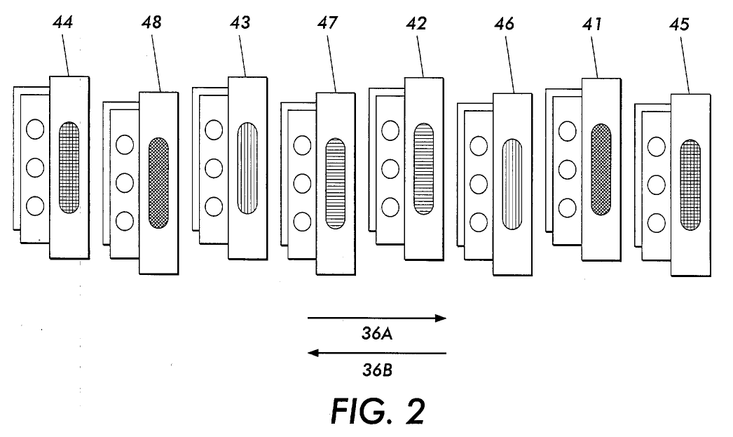

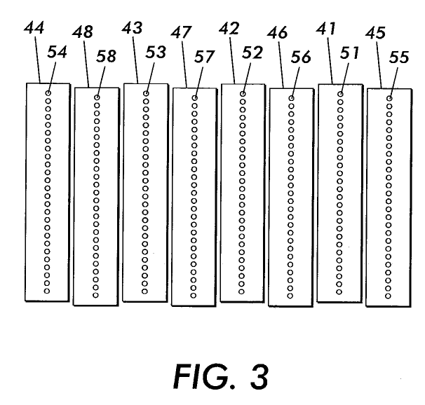

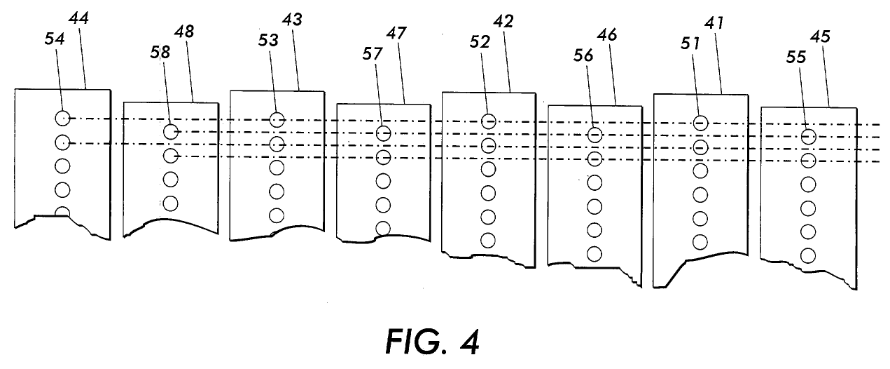

One or more printheads 41-48 (FIGS. 1 and 2) are contained in the housing. The printheads travel in a printhead travel direction 36. The printheads 41-48 use ink jetting, such as thermal ink jet or piezo-electric ink jet technology, to eject drops of ink from nozzles 50 in nozzle plates 51-58 on the bottom of the printheads (FIGS. 3 and 4) as the printheads travel in the printhead travel direction. These ink drops are directed toward a print medium to form dots on the print medium. The dots deposited on the print medium form a swath of an image as the printhead moves across the print medium. After the image swath is printed, the media transport mechanism of the printer advances the media in a media travel direction. The media travel direction is substantially transverse or perpendicular to the printhead travel direction. The media transport mechanism generally advances the print medium approximately the width of the printheads after a swath of the image is printed, so that the printheads can print an adjacent swath of the image. A controller 60 is configured or programmed to control the operations of the printer, including movement of the printhead(s), the ejection of ink drops from the printhead(s), and the movement of print medium.

The printheads 41-48 are shown stylistically in FIG. 1. Although plural separate printheads are shown, the principles described herein can be used with a single printhead that includes separate printhead sections. Thus, references herein to a set of printheads incorporate a set of printhead sections of a single printhead. The printheads shown are marked with a color representative of the color that particular printhead ejects, for ease of understanding the description. Actual printheads need not be so colored.

A first set of the printheads 41-44 includes one printhead for ejecting each color of the set of colors used by the printer. The first set of printheads is arranged in a first color order in the printhead travel direction. In the illustrated example, the printheads of the first set are arranged, from right to left, black (K) printhead 41, cyan (C) printhead 42, magenta (M) printhead 43, and yellow (Y) printhead 44. These printheads of the first set deposit the ink in the first color order (KCMY) as the printheads move in a first or forward printhead travel direction 36A from left to right across the print medium.

A second set of the printheads 45-48 includes a printhead for ejecting each of the colors of the same set of colors provided by the first set of printheads. The printheads of the second set of printheads are arranged in a color order that is different from the first color order of the first set of printheads 41-44. In particular, the color order of the second set of printheads is opposite the color order of the first set of printheads. Thus, if the first set of printheads 41-44 is arranged (right to left) black, cyan, magenta, and yellow, the second set of printheads 45-48 is arranged, from right to left, yellow (Y) printhead 45, magenta (M) printhead 46, cyan (C) printhead 47, and black (K) printhead 48. Thus, as the printheads move in the forward printhead travel direction 36A, the printheads 45-48 of the second set deposit the ink in the second color order (YMCK).

Each printhead 41-48 has a plurality of ink ejection nozzles 51-58 on a nozzle plate that faces the media. As seen in FIGS. 3 and 4, each printhead has a column of ink ejection nozzles, with the column oriented substantially perpendicular to the printhead travel direction 36. Those skilled in the art will recognize that other arrangements of nozzles can be used.

The nozzles 55-58 of the printheads 45-48 of the second set of printheads are offset in a direction other than the printhead travel direction from the nozzles 51-54 of the printheads 41-44 of the first set of printheads. In particular, the printhead nozzles of the first set of printheads are offset from the printhead nozzles of the second set of printheads in a direction transverse (perpendicular) to the printhead travel direction, which is essentially the same as the media travel direction 34. In FIGS. 1-4, the offset of the printhead nozzles is illustrated as offset of the printheads themselves. FIGS. 1-4 show the offset in an exaggerated amount to facilitate the understanding of the principles described herein.

In the illustrated implementation, the nozzles 51-54 of the printheads 41-44 of the first set are aligned with one another in the printhead travel direction. In addition, the nozzles 55-58 of the printheads 45-48 of the second set are aligned with one another in the printhead travel direction. The nozzles 51-54 of the printheads of the first printhead set are offset from the nozzles 55-58 of the printheads of the second printhead set approximately the distance between adjacent dots formed by the ink drops ejected from the printheads. In the illustrated example, each printhead has a single column of nozzles oriented in the media travel direction (transverse to the printhead travel direction), and the printer has two printheads of each color. To print an image with a resolution of 360 dots per inch in the media travel direction, each printhead has 180 nozzles per inch in that media travel direction, so that the spacing in the media travel direction between adjacent nozzles on a single printhead is 1/180 inch (70.5 um). The printheads of the same color from the first and second sets of printheads are offset from one another in the media travel direction by a distance D that is approximately the spacing between dots in the printed image, or 1/360 inch (35.2 um). In this way, the two printheads of a particular color print alternating rows of dots in the printhead travel direction. For example, the nozzles 51 of the black printhead 41 of the first set and the nozzles 58 of the black printhead 48 of the second set are offset from one another in the media travel direction by approximately 1/360 inch (35.2 um). The nozzles 52 of the cyan printhead 42 of the first set are aligned with the nozzles 51 of the first black printhead 41. The nozzles 57 of the second cyan printhead 47 are aligned with the nozzles 58 of the second black printhead 48, and offset from the nozzles 52 of the first cyan printhead 42.

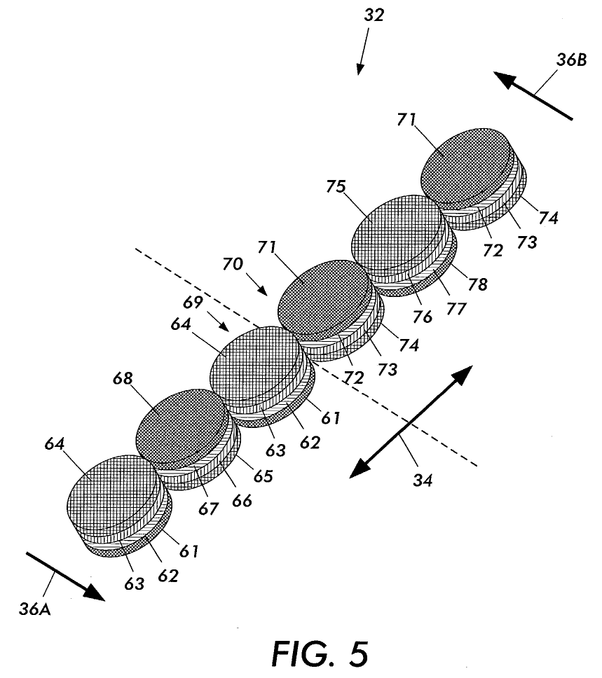

As is known to those familiar with the printing arts, the printer deposits drops of the printer ink colors on top of one another in various combinations to produce the desired printed colors. Referring now to FIG. 5, the first printheads 41-44 deposit a first set of ink drops of the specified set of colors on a set of first points on the print medium as the printheads move in the first, or forward printhead travel direction 36A. The ink drops deposited on the first points of the print medium form rows of ink dots 61-64 are oriented in the printhead travel direction. The second printheads 45-48 deposit ink drops of the specified set of colors on a set of second points on the print medium to form rows of ink dots 65-68 that are interleaved between the rows of ink dots 61-64 deposited by the first set of printheads. Alternating rows of dots are deposited by the printheads of the first and second sets of printheads, respectively. The deposited ink dots 61-68 shown in FIG. 5 are highly exaggerated to illustrate the principles involved. In addition, the dots are shown with their component individual colors, although in practice, the colors would merge to form the finished color.

The printheads 41-44 of the first set deposit ink drops in the first color order (black 61, cyan 62, magenta 63, yellow 64) on the first points as the printheads move in the forward printhead travel direction 36A (toward the right in FIGS. 1-5). As the printheads move in the forward direction, the printheads 45-48 of the second set of printheads deposit ink drops on a set of second points in the second color order (yellow 65, magenta 66, cyan 67, black 68). In the illustrated example, this second color order is the reverse of the first color order. To the extent that color differentiation or hue variation arises based on the order in which the colors of the set of colors are deposited on the print medium, such hue variation is between adjacent rows of ink dots on the print medium. For example, with 360 dots per inch, the centers of each dot 61-64 and 65-68 is approximately 1/360 inch (35.2 um) in diameter. The rows of ink dots are so closely spaced, and sufficiently fine that such hue variation between adjacent rows is invisible to the human eye. Thus, the colors printed in this forward image swath appear uniform to the human eye.

After the printhead has traversed the width of the print medium and deposited a swath of the image to be printed, the media transport mechanism moves the print medium 32 in the media travel direction 34. The media transport mechanism generally moves the medium by a distance approximately equal to the dimension of the printheads in the media travel direction (which may be considered the length of the printheads). The printheads then move in the reverse printhead travel direction 36B (right to left in FIGS. 1-5). As the printheads move in the reverse printhead travel direction, they deposit ink drops of the specified set of colors on other sets of points in the print medium. As the printheads move in the reverse printhead travel direction 36B, the second set of printheads 45-48 deposit ink drops on the print medium in the same color order as the first set of printheads 41-45 did in the forward printhead travel direction 36A as the printheads move in the reverse printhead travel direction 36B, on a particular point, the black printhead 48 of the second set deposits a black drop 78 first, followed by the cyan printhead 47 of the second set depositing a cyan drop 77. Then the second magenta printhead 46 deposits a magenta drop 76, and finally the second yellow printhead 45 deposits a yellow drop 75. Thus, the printheads 45-48 of the second set of printheads deposit ink drops on a set of third points on the print medium in the first color order (KCMY). The printheads of the first set of printheads (moving in the reverse printhead travel direction 36B) deposit ink drops on a set of fourth points in the second color order (YMCK). The first yellow printhead 44 deposits a yellow drop 74, followed by the first magenta printhead 43 depositing a magenta drop 73. Then, the first cyan printhead 42 deposits a cyan drop 72, and the first black printhead 41 deposits a black drop 71. Again, hue variations between the dots 75-78 formed by the printheads of the second set, and the dots 71-74 formed by the printheads of the first set as the printhead moves in the reverse printhead travel direction are generally not visible to the human eye.

The printheads can be arranged and operated so that nozzles of the first set of printheads 41-44 deposit the ink drops forming the “last” row of dots 69 in the forward image swath and the ink drops forming the “first” row of dots 70 in the reverse image swath. As seen in FIG. 5, such an arrangement continues the alternating color order in which the dots are “built.” Thus, any resulting hue variation is no more than one dot in width, too small to be generally visible. However, benefit is still achieved if the second set of printheads 45-48 deposits the “first” row of dots of the reverse image swath. Such an arrangement would yield two adjacent rows of dots deposited in the same color order, any color hue variation between such rows is still sufficiently small that it would generally not be visible to the human viewer.

FIG. 7 shows an implementation of the present invention having printheads in which printheads of a first set of printheads 141-144 are aligned to produce one set of rows of dots. The printheads 141-144 of the first set are grouped together. Printheads of a second set of printheads 145-148 are aligned to fill in the intervening rows of dots between the rows of dots produced by the printheads 141-144 of the first set. The nozzles of the printheads 145-148 of the second set are offset from the nozzles of the printheads 141-144 of the first set in the media travel direction by an amount approximately equal to the distance between adjacent dots formed by the printheads. The nozzle offset can be provided by offsetting the printheads themselves. Although a one dot offset is advantageous, essentially any number of odd numbers of dots offset can be used, with appropriate stitching of the images from the different swaths of the printhead as it moves across the medium. The offset is determined by the size of the dot formed by each ink drop as it is deposited on the print medium.

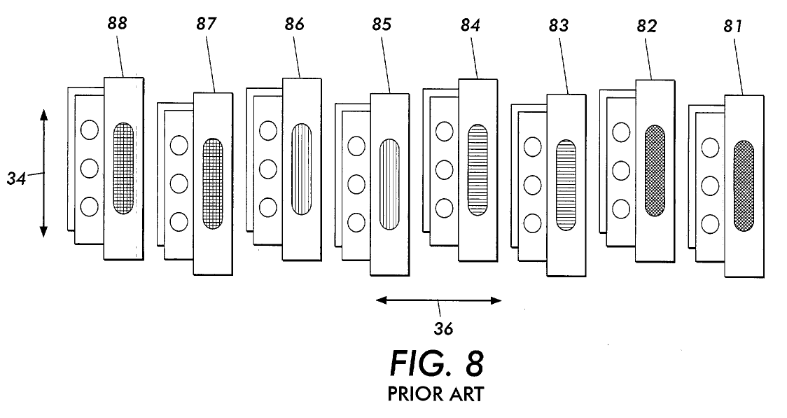

Referring to a printhead construction of a current design as shown in FIG. 8, two or more printheads of each color are positioned adjacent one another in the printhead travel direction, and offset from one another in the media travel direction. Two black printheads 81, 82 are offset from one another in the media travel direction 34 by a distance approximately equal to the spacing of an odd number of resulting printed dots. Generally, the offset distance is approximately equal to the spacing of adjacent dots. Similarly, the two cyan printheads 83, 84 are offset from one another. One of the cyan printheads 83 is aligned with one of the black printheads 81, and the other cyan printhead 84 is aligned with the other of the black printheads 82. The two magenta printheads 85, 86 are offset from one another and aligned with corresponding ones of the cyan and black printheads. The two yellow printheads 87, 88 are also offset from one another and aligned with the corresponding ones of the magenta, cyan, and black printheads.

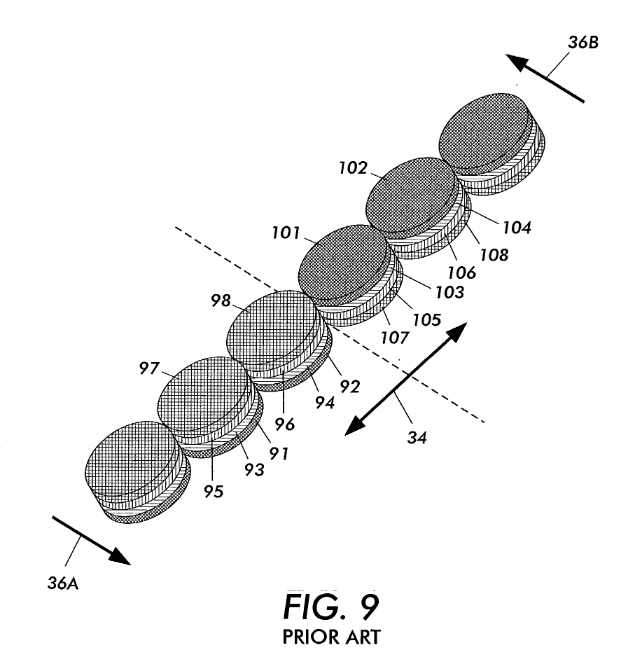

The printheads of FIG. 8 deposit ink drops to form ink dots on the print medium as shown in FIG. 9. All of the dots forming a swath of the image are deposited in the same color order. As seen in FIG. 9, the dots formed as the printhead moves in a forward printhead travel direction 36A (left to right across the print medium) are formed with the black dot 91, 92 first, the cyan dot 93, 94 next, then the magenta dots 95, 96, and finally the yellow dots 97, 98. These first dots form a forward swath of the printed image. As the printhead moves in the reverse printhead travel direction 36B (after the media has been moved), the dots forming the reverse swath of the image are all formed by first depositing yellow dots 107-108, then magenta dots 105, 106, then cyan dot 103, 104, and finally black dots 101, 102. All of the dots 101-108 on that reverse swath of the image are formed with the ink being deposited in the same order. For colors in which the hue differs depending on the order in which the ink colors are deposited, the portion of the image formed of the dots in the forward swath may differ slightly from the portion of the image formed by the dots in the reverse swath. Because the entire swath of the image has the same hue, variation between the hue of the forward swath and the hue of the reverse swath is likely to be visible to the human eye.

With the preceding teaching, those skilled in the art will be able to identify various modifications to the specific implementations described that do not depart from the invention. For example, different configurations or orders of printheads, as well as different combinations of individual and multiple printheads can be formed. In addition, different types of ink ejection technology, including thermal ink jet and piezoelectric ink jet, as well as others can be used. Therefore, the present invention is not limited to the specific implementations described above.

We claim:

1. A printer having a printhead travel direction and a transverse direction, substantially perpendicular to the printhead travel direction, the printer comprising:
a plurality of first printheads, each of which is for ejecting a different color of a set of colors;
a plurality of second printheads, each of which is for ejecting one of the colors of the set of colors;
wherein the first printheads are arranged in a first color order in the printhead travel direction; and
wherein the second printheads are arranged in a second color order in the printhead travel direction, different from the first color order.

2. The printer of claim 1, wherein the second color order is the reverse of the first color order.

3. The printer of claim 1, wherein each of the second printheads is offset in the transverse direction from the first printhead for ejecting the same color by a predetermined distance.

4. The printer of claim 3, wherein predetermined distance is approximately equal to the distance between adjacent dots formed by the printheads.

5. The printer of claim 3, wherein predetermined distance is approximately equal to an odd whole number multiple of the distance between adjacent dots formed by the printheads.

6. A printer assembly comprising:
a first set of printheads arranged in a first direction; and
a second set of printheads arranged in the first direction;
wherein each of the sets of printheads has printheads of the same colors;
wherein the printheads of the first set are arranged in the reverse color order of the printheads of the second set;
wherein the printheads of the same color of the first and second sets are offset from one another in a second direction.

7. The printer assembly of claim 6, wherein the printheads of the first and second sets of printheads are offset from one another in the first direction.

8. A printer having a printhead travel direction and a media travel direction, the printer comprising:
a first forward printhead for ejecting a first color ink;
a first reverse printhead for ejecting the first color ink;
a second forward printhead for ejecting a second color ink; and
a second reverse printhead for ejecting the second color ink;
wherein the first reverse printhead is offset in the media travel direction from the first forward printhead;
wherein the first reverse printhead is offset in the media travel direction from the first forward printhead;
both the second forward printhead and the second reverse printhead are between the first forward printhead and the first reverse printhead in the printhead travel direction.

9. The printer of claim 8, additionally comprising:
a third forward printhead for ejecting a third color ink;
a third reverse printhead for ejecting the third color ink;
a fourth forward printhead for ejecting a fourth color ink; and
a fourth reverse printhead for ejecting the fourth color ink;
wherein the third reverse printhead is offset in the media travel direction from the third forward printhead;
wherein the third reverse printhead is offset in the media travel direction from the third forward printhead;
both the fourth forward printhead and the fourth reverse printhead are between the third forward printhead and the third reverse printhead in the printhead travel direction.

10. A method of printing an image on a print medium, the method comprising:
moving a set of printheads in a forward printhead travel direction across the print medium;
as the set of printheads moves in the forward printhead travel direction:
depositing a first set of ink drops of a specified set of colors on a set of first points on the print medium;
depositing the ink drops on the first points in a first color order;
depositing a second set of ink drops of the specified set of colors on a set of second points on the print medium;
depositing the ink drops on the second points in a second color order;
wherein the second color order is different from the first color order;
wherein the second points are offset from the first points in a direction other than the printhead travel direction.

11. The method of claim 10, wherein the second color order is the reverse of the first color order.

12. The method of claim 10, wherein the second points are offset from the first points in a direction transverse to the printhead travel direction.

13. The method of claim 12, wherein the second points are offset from the first points by a distance approximately equal to the diameter of a dot formed by an ink drop.

14. The method of claim 12, wherein the second points are offset from the first points by approximately a distance approximately equal to an odd whole number multiple of the diameter of a dot formed by an ink drop.

15. The method of printing an image of claim 10, additionally comprising:
moving the print medium in a media travel direction, substantially perpendicular to the printhead travel direction;
moving the set of printheads in a reverse printhead travel direction;
as the set of printheads moves in the reverse printhead travel direction:
depositing a third set of ink drops of the specified set of colors on a set of third points on the print medium;
depositing the ink drops on the third points in the first color order;
depositing a fourth set of ink drops of the specified set of colors on a set of fourth points on the print medium;
depositing the ink drops on the fourth points in the second color order;
wherein the fourth points are offset from the third points in a direction other than the printhead travel direction.

16. The method of claim 15, wherein the second color order is the reverse of the first color order.

17. The method of claim 16, wherein:
the second points are offset from the first points in the media travel direction; and
the fourth points are offset from the third points in the media travel direction.

18. The method of claim 17, wherein:
the second points are offset from the first points by a distance approximately equal to the diameter of a dot formed by an ink drop; and
the fourth points are offset from the third points by a distance approximately equal to the diameter of a dot formed by an ink drop.

19. The method of claim 18, wherein:
the printheads have a length in the media travel direction; and
the third and fourth points are offset from the first and second points in the media travel direction by a distance approximately equal to the length of a printhead.

20. The method of claim 17, wherein:
the second points are offset from the first points by approximately a distance approximately equal to an odd whole number multiple of the diameter of a dot formed by an ink drop; and
the fourth points are offset from the third points by approximately a distance approximately equal to an odd whole number multiple of the diameter of a dot formed by an ink drop.
